(19) United States
(12) Patent Application Publication
(10) Pub. No.: US 2010/0273122 A1
(43) Pub. Date: Oct. 28, 2010

(54) Method and intra-oral device for smoking cessation or alcohol cessation

(76) Inventors: Victoria Vilshenker, Los Angeles, CA (US); Pavel Morozov, Los Angeles, CA (US)

Correspondence Address: Mr. Pavel Morozov, 445 1/2 N. Sierra Bonita Ave. Apt. 1, Los Angeles, CA, 90036, US

(21) Appl. No.: 12/387,087

(22) Filed: Apr. 27, 2009

(51) Int. Cl. A61C 1/00

(52) U.S. Cl. 433/27

(57) ABSTRACT

This invention is an improved method and intra-oral device for smoking cessation or alcohol cessation. Specifically, this method requires the use of an intra-oral device comprised of a carbon monoxide sensor, ethanol sensor, sensor supervising and signal processing circuit, power source, electrodes, mounting element. The intra-oral device is used in association with the molar tooth via the mounting element which provides affixation to the device. During the process of smoking, the carbon monoxide sensor of the intra-oral device detects the threshold of carbon monoxide in the smoke entering the mouth. The sensor supervising and signal processing circuit is set into an activation mode, which triggers an electrical stimulation of the neck of the tooth via two electrodes of the device. During the process of alcohol consumption, the ethanol sensor of the intra-oral device detects the threshold of ethanol in the mouth. The sensors supervising and signal processing circuit is set into an activation mode, which triggers an electrical stimulation of the neck of the tooth via two electrodes of the device. The intra-oral device can be programmed in different modes providing varied levels of electrical stimulation via the two electrodes, from slight irritation to light pain which is delivered to the neck of the tooth. This works as negative reinforcement to the smoker or drinker, preventing them from continuation of the smoking session or drinking session. By using one such device the smoker or drinker is behaviorally conditioned to cease further attempts at smoking or drinking.

### TECHNICAL FIELD AND INDUSTRIAL APPLICABILITY OF THE INVENTION

This invention relates to a method and intra-oral device for smoking cessations or alcohol cessation.

### BACKGROUND OF THE INVENTION

According to the American Lung Association, smoking is responsible for approximately one in five deaths in the United States. From 1997 to 2001, smoking killed approximately 438,000 people in the United States alone, each year. This includes an estimated 259,494 male and 178,408 female deaths annually.

People start smoking for a range of reasons, such as, stress, daily problems, peer pressure, genetic history, and individual characteristics. There are many reasons people want to quit smoking, such as; health problems, odor, stained teeth, bad breath, wrinkled skin, and yellow nails, all related with smoking. According to statistics, smoking can cause the average male to lose 13.2 years of his life, and the average female to lose 14.5 years of her life.

There have been many inventions devoted to smoking cessation.

Many inventions have been created to help people quit smoking. U.S. Pat. No. 7,156,109 to Sampson (2007) provides the combination of the dental tool with the accompanying medicament that satisfies a smoker's craving for nicotine.

U.S. Pat. No. 7,100,618 to Dominguez (2006) provides the capability to generate mental effect similar to that of smoking but less dangerous to a person's health. U.S. Pat. No. 7,094,787 to Okubo (2006) employs a composition for suppressing craving for smoking.

U.S. Pat. No. 7,028,693 to Brue reduces the number of cigarettes consumed by a smoker. U.S. Pat. No. 6,845,777 to Pera (2005) utilizes an arrangement that can take a capsule, powder, or liquid form, and that satisfies a smoker's desire for nicotine. U.S. Pat. No. 6,596,740 to Jones (2003) satisfies a smoker's craving for nicotine via a nasal spray.

Other smoking cessation inventions are as follows, but are not restricted to, spinal cord stimulation (i.e., U.S. Pat. No. 6,233,488 to Hess (2001)); cigarette aeration and filtration devices (i.e., U.S. Pat. No. 5,954,061 (1999)); wristwatches (i.e., U.S. Pat. No. 6,305,939 to Krstulovic (2001)); and chemotherapy (i.e., U.S. Pat. No. 6,333,357 to Eig (2001)).

Although, there are a multitude of ways through which people have tried to quit smoking, a very small percentage of those people, that try, actually succeed and only about 5% percent of them succeed in the long run.

Other addictions to substances, such as marijuana or alcohol have a detrimental effect on society, as well.

There is definitely still a need for more effective ways to quit smoking, because, each case of smoking addiction is highly individualized from person to person, and requires a unique mode of treatment.

The inventions and patents described above, taken independently or combined, are not seen as instant inventions as claimed.

While these devices accomplish their corresponding requirements and objectives, the here mentioned patents do not describe a method and intro-oral device for treating addictions

Although every year more than 15 million people attempt to quit smoking, only about five percent of them succeed on a long run

In this respect, a method and intro-oral device for smoking cessations or alcohol cessation according to the present invention considerably departs from the standard concepts and designs of the prior art.

Therefore, it must be understood that there is a continuing need for new methods and devices for treating addictions

### SUMMARY OF INVENTION

This invention is a method and intra-oral device for smoking cessation or alcohol cessation. Specifically, this method requires the use of an intra-oral device comprised of a carbon monoxide sensor, ethanol sensor, sensor supervising and signal processing circuit, power source, electrodes, and mounting element. The intra-oral device is used in association with the molar tooth via the mounting element providing affixation to the device. During the process of smoking, the carbon monoxide sensor of the intra-oral device detects the threshold of carbon monoxide in the smoke entering the mouth. The sensor supervising and signal processing circuit is set into an activation mode, which triggers an electrical stimulation of the neck of the tooth via two electrodes of the device. During the process of alcohol consumption, the ethanol sensor of the intra-oral device detects the threshold of ethanol in the mouth. The sensor supervising and signal processing circuit is set into an activation mode, which triggers an electrical stimulation of the neck of the tooth via two electrodes of the device. The intra-oral device can be programmed in different modes providing varied levels of electrical stimulation via the two electrodes, from slight irritation to light pain which is delivered to the neck of the tooth. This works as negative reinforcement to the smoker or drinker, preventing them from continuation of the smoking session or drinking session. By using one such device the smoker or drinker is behaviorally conditioned to cease further attempts at smoking or drinking.

### BRIEF DESCRIPTION OF THE DRAWINGS

Without limiting the full scope of this invention, the preferred form of this invention is illustrated in the following drawing:

FIG. 1 is a perspective view of the preferred embodiment of the Intro-oral device for treating addictions constructed in accordance with the principles of the present invention.

FIG. 2 is a perspective view of the Intro-oral device associated with the tooth, and installed in the third molar area.

FIG. 3 is an enlarged, partially broken away perspective view of the apparatus illustrating the positioning of the Intro-oral device.

FIG. 4 is an enlarged, partially broken away side perspective view taken along section line 4-4 of FIG. 3 illustrating the apparatus coupled to a molar tooth.

FIG. 5 is an enlarged, partially broken away side perspective view indicated by line 5 of FIG. 3 illustrating the apparatus's electrode coupled to a molar tooth.

FIG. 6 is an enlarged, partially broken away perspective view of the apparatus illustrating the positioning of the carbon monoxide sensor, ethanol sensor, sensor supervising and signal processing circuit, and power source.

FIG. 7 is an enlarged, partially broken away perspective view of the apparatus illustrating the positioning of the perforation made on the body of the apparatus.

FIG. 8 is a block diagram illustrating the Intro-oral device for smoking cessation or alcohol cessation containing the carbon monoxide sensor according to the one embodiment.

FIG. 9 is a block diagram illustrating the Intro-oral device for smoking cessation or alcohol cessation containing the ethanol sensor according the one embodiment.

FIG. 10 is a block diagram illustrating the Intro-oral device for smoking cessation or alcohol cessation containing the carbon monoxide and ethanol sensor according the one embodiment.

The same reference numerals refer to the same parts through the various Figures.

### DRAWINGS—REFERENCE NUMERALS

100—Intro-oral device for treating addictions

101—Electrodes

102—Orthodontic band

103—Electrodes cover

110—Power Supply

112—Carbon Monoxide Sensor

114-Sensor Supervising and Signal Processing Circuit

116—Wires

118—Wires

122—Ethanol sensor

124—Wires

128—Wires

130—Perforation's element (hole)

200—Molar tooth

300—Dental cement adhesive

### DETAILED DESCRIPTION AND PREFERRED EMBODIMENT

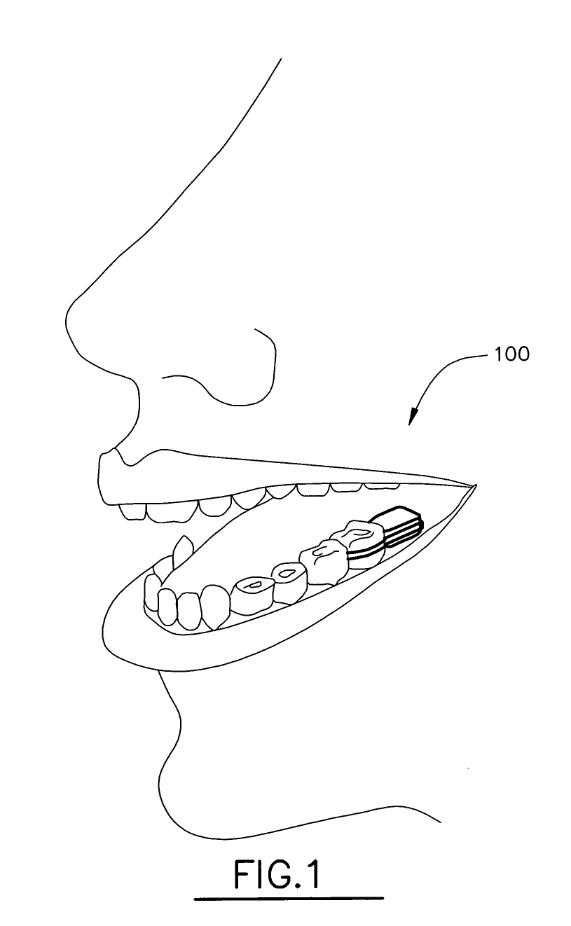

Referring now to the drawings, and in regards to, FIG. 1 thereof, the preferred actualization of the new intra-oral device for smoking cessation or alcohol cessation correlated with the principles and concepts of the present invention and herein referenced by the number 100 will be described in the following statements.

It will be noted in the following Figures, that the device relates to an intra-oral device for smoking cessation or alcohol cessation. In the full context, the device consists of a carbon monoxide sensor 112, ethanol sensor 122, sensor supervising and signal processing circuit 114, power supply 110, electrodes 101, orthodontic band 102 and dental cement adhesive 300 providing affixation the device with molar tooth.

As known, one of the components of cigarette smoke is carbon monoxide, in high concentrations of up to 8%. The device is shown operating in the following description. A power supply 110 provides power to the unit 100. A carbon monoxide sensor 112 provides detection of carbon monoxide. A sensor supervising and signal processing circuit 114 is coupled to and in communication with the carbon monoxide sensor 112. The sensor supervising and signal processing circuit 114 generates an electrical signal sending to electrodes 101 upon detecting a threshold of carbon monoxide. The two electrodes 101 are coupled to and in communication with the sensor supervising and signal processing circuit 114.

During operation, the unit 100 is powered by the electrical power supply 110 and is in a monitoring mode. If the carbon monoxide sensor 112 detects the threshold of carbon monoxide, the sensor supervising and signal processing circuit 114 is set into activation mode, which triggers an electrical stimulation of the neck of the tooth via two electrode 101 of the device for as long as the threshold of carbon monoxide is being detected.

During the process of alcohol consumption, the ethanol sensor 122 of the intra-oral device detects the threshold of ethanol in the mouth. The sensor supervising and signal processing circuit 114 is set into an activation mode, which triggers an electrical stimulation of the neck of the tooth via two electrodes 101 of the device for as long as the threshold of ethanol is being detected.

The intra-oral device can be programmed in different modes providing varied levels of electrical stimulation, from slight irritation to light pain which is delivered to the neck of the molar tooth. This works as negative reinforcement to the smoker or drinker, preventing them from continuation of the smoking session or drinking session. By using one such device the smoker or drinker is behaviorally conditioned to cease further attempts at smoking or drinking.

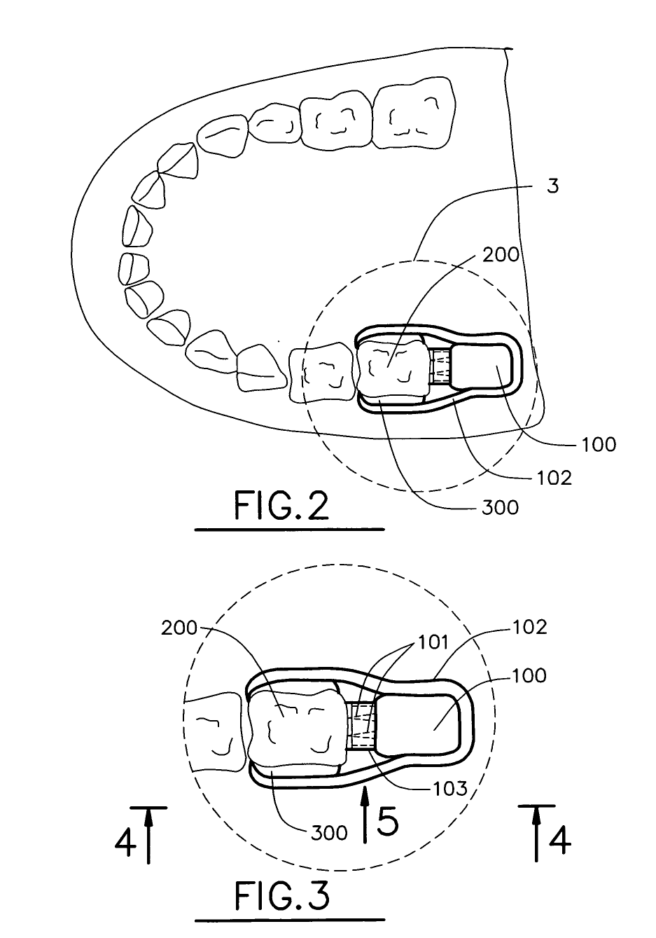

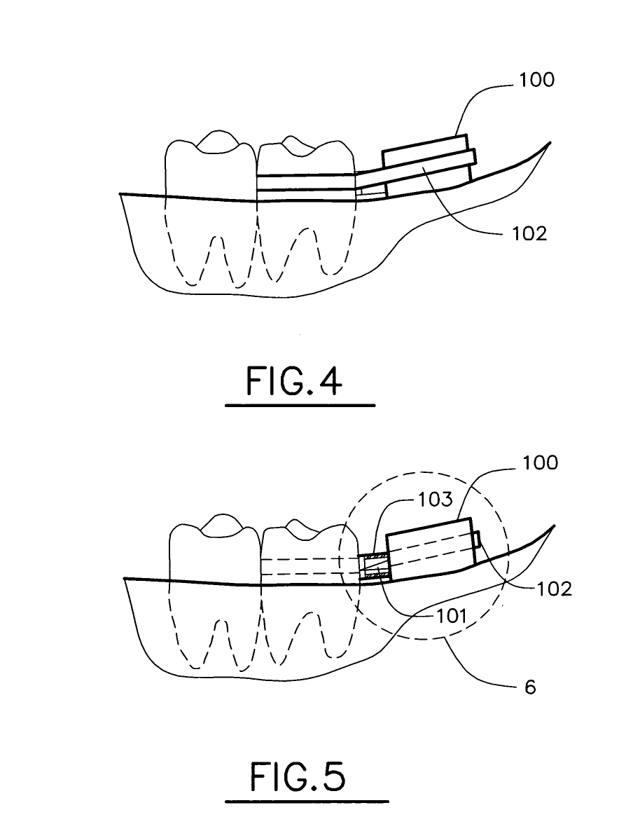

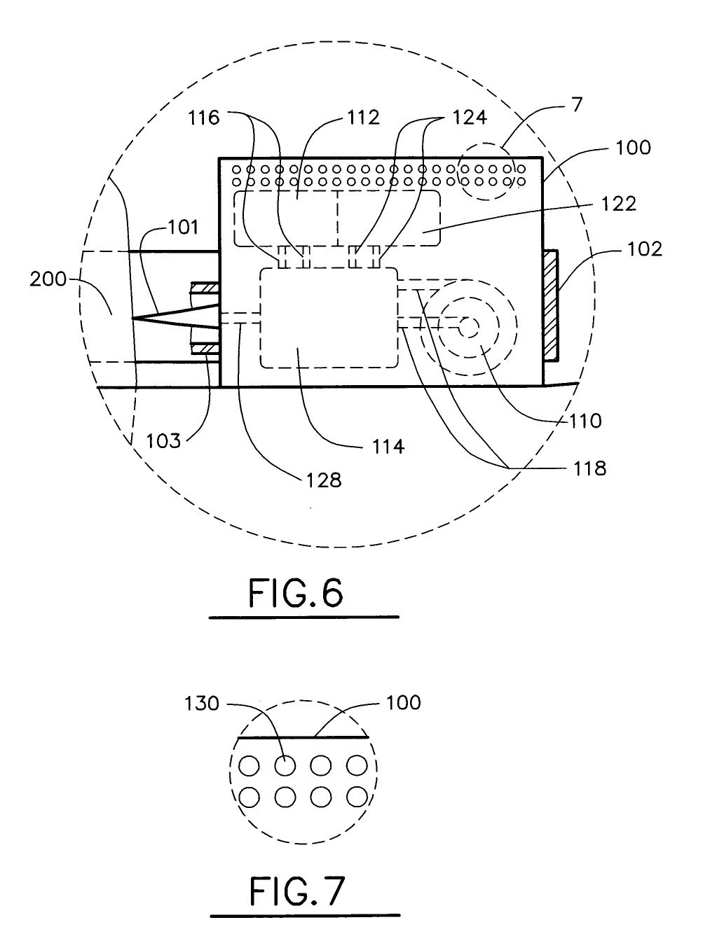

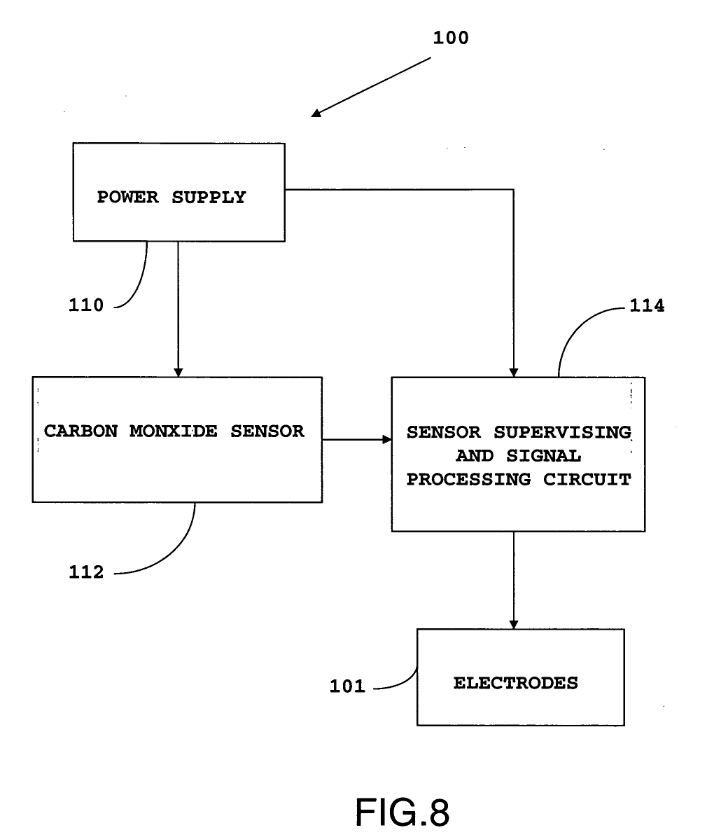

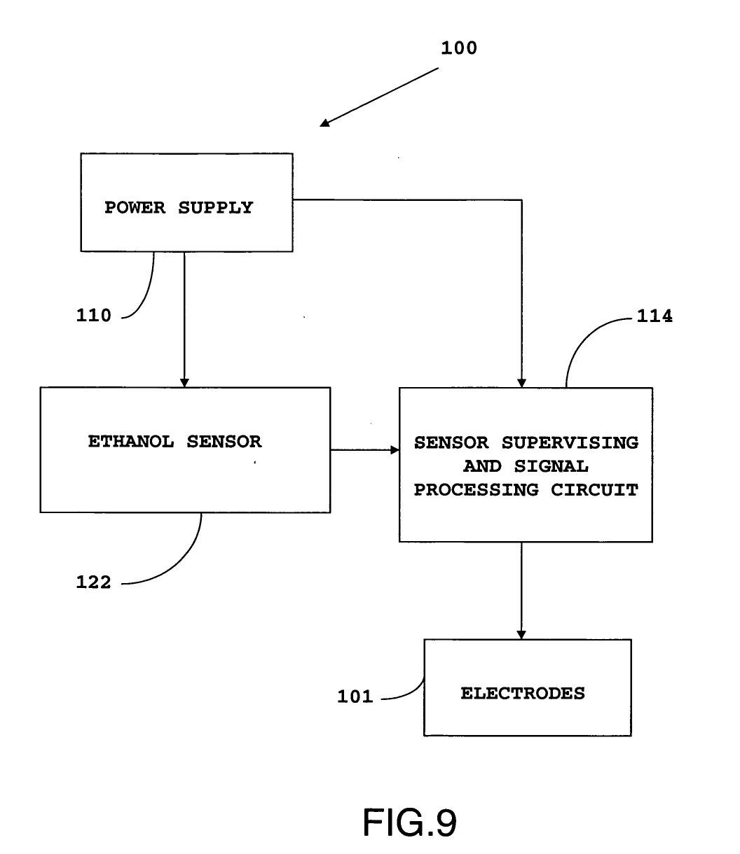

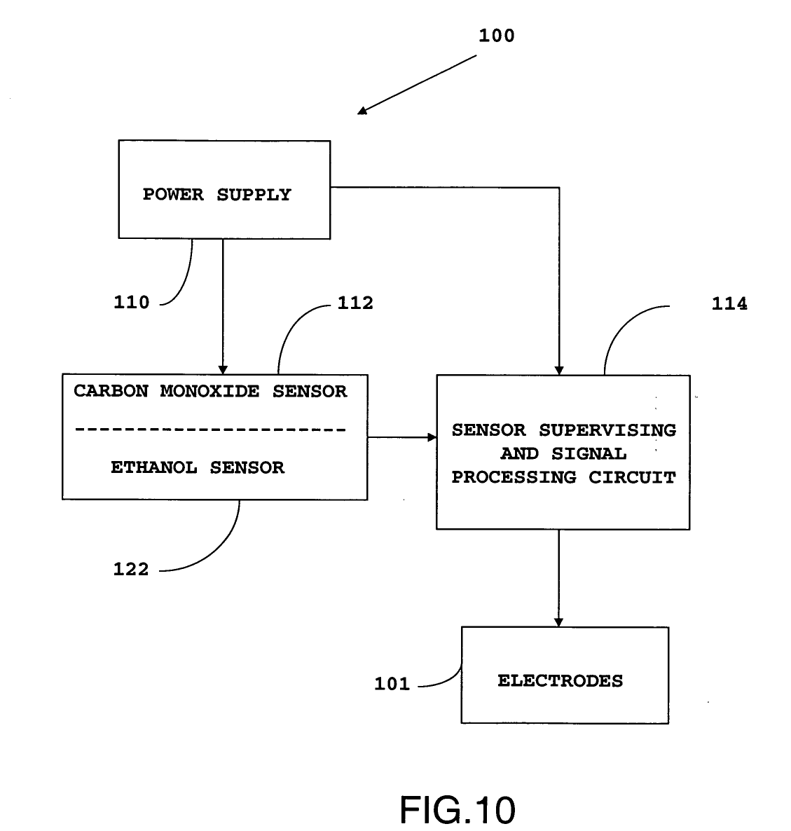

FIGS. 1-10 show only a few samples of all of the possible variations that are available within the foregoing disclosure of the new intra-oral device for smoking cessation or alcohol cessation.

As to the way of usage and operation of the current invention, the same should be evident from the above description. Accordingly, no further consideration relating to the way of usage and operation will be provided.

Concerning the above description, then, it is to be understood that the most efficient dimensional relationships for the parts of the invention, to comprise differences in size, materials, shape, form, function and the way of operation, assembly and use, are readily apparent and evident to one skilled in the art, and all equivalent relationships to those illustrated in the drawings and described in the specifications are intended to be included by the present invention.

Therefore, the statements listed above are considered as illustrative only of the principles of the invention. Further, since numerous innovations will occur to those skilled in the art, it is not desired to limit the invention to the exact construction and operation described and shown, and accordingly, all suitable enhancements may be achieved within the scope of the invention.

What is claimed is:

1. Method and intra-oral device for smoking cessations or alcohol cessation comprising:
carbon monoxide sensor, sensor supervising and signal processing circuit, power source, electrodes, mounting element providing affixation of the device to the tooth.

2. Method and device according to claim 1, comprising ethanol sensor.
